(19) United States
(12) Patent Application Publication
(10) Pub. No.: US 2026/0188316 A1
(43) Pub. Date: Jul. 2, 2026

(54) AUTO REPLY DEVICE, AUTO REPLY METHOD, AND COMPUTER PROGRAM FOR AUTO REPLY

(71) Applicant: TOYOTA JIDOSHA KABUSHIKI KAISHA, Toyota-shi (JP)

(72) Inventors: Yasufumi KAWANO, Tokyo-to (JP); Yusuke YACHIDE, Tokyo-to (JP)

(73) Assignee: TOYOTA JIDOSHA KABUSHIKI KAISHA, Toyota-shi (JP)

(21) Appl. No.: 19/400,630

(22) Filed: Nov. 25, 2025

(30) Foreign Application Priority Data
Dec. 26, 2024 (JP) 2024-230861

(51) Int. Cl. G10L 15/22; B60K 35/10; B60K 35/26

(52) U.S. Cl. CPC G10L 15/22; B60K 35/10; B60K 35/265; G10L 2015/228

(57) ABSTRACT

An auto reply device includes a processor configured to: determine candidates for reply that may be requested by an occupant of a vehicle, based on at least one of history of reply to an utterance of the occupant, vehicle exterior information, and vehicle interior information, determine, for each candidate for reply, a combination of possible utterance data representing an utterance expected at requesting the reply and command data for making the reply, recognize an utterance of the occupant from a voice signal picked up by a microphone installed in the vehicle, select a candidate for reply corresponding to the possible utterance data that best matches the recognized utterance from among the candidates for reply, and reply according to the command data for the selected candidate for reply.

### FIELD

The present invention relates to an auto reply device that automatically replies to an utterance of an occupant of a vehicle, an auto reply method, and a computer program for auto reply.

### BACKGROUND

A technique of controlling a vehicular device by voice has been proposed (see Japanese Unexamined Patent Publication No. 2006-137366). In this technique, a vehicular device controller converts inputted voice to text, refers to operation history for the relation between the text and past operation to infer a device to be operated, and sets a priority for each device. The vehicular device controller selects a device or a type of device operation, based on the priority for each device, and instructs the selected device to execute operation corresponding to the text.

### SUMMARY

Large language models (LLM) that automatically generate a reply to a question have been researched. However, since a LLM executes a large amount of computation, the use of a LLM for generating a reply to an utterance of a vehicle occupant may result in too long a wait time from the occupant's utterance to execution of some reply process.

An object of the present invention is to provide an auto reply device that can shorten a wait time until reply depending on an utterance of a vehicle occupant.

According to an embodiment, an auto reply device is provided. The auto reply device includes a processor configured to: determine candidates for reply that may be requested by an occupant of a vehicle, based on at least one of history of reply to an utterance of the occupant, vehicle exterior information representing conditions around the vehicle, and vehicle interior information representing conditions inside the vehicle, determine, for each of the candidates for reply, a combination of possible utterance data representing an utterance expected at requesting the reply and command data for making the reply, recognize an utterance of the occupant from a voice signal picked up by a microphone installed in the vehicle, select a candidate for reply corresponding to the possible utterance data that best matches the recognized utterance from among the candidates for reply, and reply according to the command data for the selected candidate for reply.

In an embodiment, the processor determines the candidates for reply by inputting at least one of the history of reply, the vehicle exterior information, and the vehicle interior information into a candidate determination model pre-trained to determine the candidates for reply.

In an embodiment, the processor calculates a degree of match between the recognized utterance and the possible utterance data for each of the candidates for reply, and does not select any of the candidates for reply when the degree of match of any of the candidates for reply is less than a predetermined selection threshold. When none of the candidates for reply is selected, the processor generates the command data by inputting the recognized utterance into a generation model pre-trained to generate the command data corresponding to the utterance, and replies according to the generated command data. The microphone 4, which is another example of the vehicle interior sensor, picks up a voice of an occupant in the vehicle 1 and outputs a voice signal representing the voice. To achieve this, the microphone 4 is installed in the interior of the vehicle 1. The vehicle 1 may include multiple microphones 4. In this case, the microphones 4 may be installed in the form of an array or near respective seats in the interior of the vehicle 1. The microphone 4 outputs a generated voice signal to the auto reply device 6. A voice signal generated by the microphone 4 is another example of an interior sensor signal.

According to another embodiment, an auto reply method is provided. The auto reply method includes determining candidates for reply that may be requested by an occupant of a vehicle, based on at least one of history of reply to an utterance of the occupant, vehicle exterior information representing conditions around the vehicle, and vehicle interior information representing conditions inside the vehicle; generating, for each of the determined candidates for reply, a combination of possible utterance data representing an utterance expected at requesting the reply and command data for making the reply; recognizing an utterance of the occupant from a voice signal picked up by a microphone installed in the vehicle; selecting a candidate for reply corresponding to the possible utterance data that best matches the recognized utterance from among the candidates for reply; and replying according to the command data for the selected candidate for reply.

According to still another embodiment, a non-transitory recording medium that stores a computer program for auto reply is provided. The computer program includes instructions causing a computer to execute a process including determining candidates for reply that may be requested by an occupant of a vehicle, based on at least one of history of reply to an utterance of the occupant, vehicle exterior information representing conditions around the vehicle, and vehicle interior information representing conditions inside the vehicle; generating, for each of the determined candidates for reply, a combination of possible utterance data representing an utterance expected at requesting the reply and command data for making the reply; recognizing an utterance of the occupant from a voice signal picked up by a microphone installed in the vehicle; selecting a candidate for reply corresponding to the possible utterance data that best matches the recognized utterance from among the candidates for reply; and replying according to the command data for the selected candidate for reply.

The auto reply device of the present disclosure has an advantageous effect of being able to shorten a wait time until reply depending on an utterance of a vehicle occupant.

### BRIEF DESCRIPTION OF DRAWINGS

FIG. 1 schematically illustrates the configuration of a vehicle equipped with an auto reply device.

FIG. 2 illustrates the hardware configuration of the auto reply device.

FIG. 3 is a functional block diagram of a processor of the auto reply device.

FIG. 4 illustrates an overview of an auto reply process of the embodiment.

FIG. 5 is a flowchart of operation of the auto reply device.

### DESCRIPTION OF EMBODIMENTS

An auto reply device as well as an auto reply method and a computer program for auto reply executed by the auto reply device will now be described with reference to the attached drawings. The auto reply device determines candidates for reply that may be requested by an occupant of a vehicle, and determines, for each of the determined candidates for reply, a combination of possible utterance data representing an utterance expected at requesting the reply and command data for making the reply. In addition, the auto reply device recognizes an utterance of the occupant from a voice signal picked up by a microphone installed in the vehicle, and selects a candidate for reply corresponding to the possible utterance data that best matches the recognized utterance from the candidates for reply. The auto reply device then replies according to the command data for the selected candidate for reply, thereby shortening a wait time from an occupant's utterance until reply.

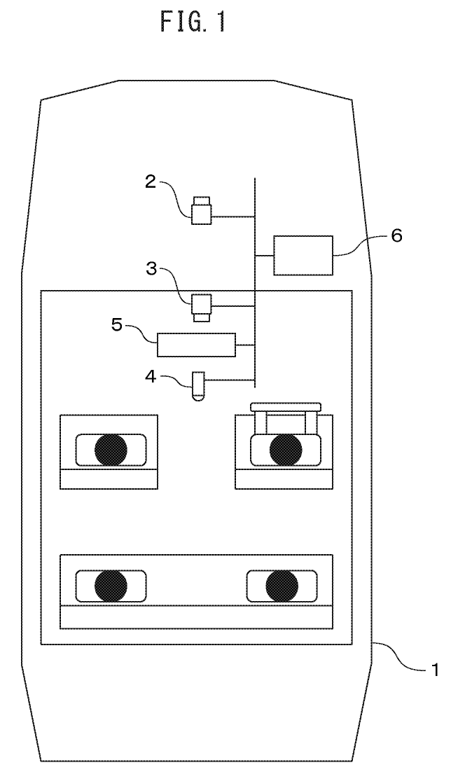

FIG. 1 schematically illustrates the configuration of a vehicle equipped with the auto reply device. In the present embodiment, the vehicle 1 includes at least one vehicle exterior sensor 2, at least one vehicle interior sensor 3, a microphone 4, a notification device 5, and an auto reply device 6. Each vehicle exterior sensor 2, each vehicle interior sensor 3, the microphone 4, and the notification device 5 are communicably connected to the auto reply device 6. In addition, the vehicle 1 may be equipped with a wireless communication terminal (not illustrated) for wireless communication with another device outside the vehicle 1.

The individual vehicle exterior sensors 2 are sensors for sensing conditions around the vehicle 1, and include, for example, a vehicle exterior camera installed to take pictures of the surroundings of the vehicle 1 or a range sensor that measures the distances to objects around the vehicle 1, such as radar or LiDAR. The individual vehicle exterior sensors 2 may include a thermometer that measures the temperature around the vehicle 1, a rain gage that measures rainfall, or a position determining device that measures the position of the vehicle 1 in conformity with a satellite positioning system, such as a GPS receiver. Each vehicle exterior sensor 2 generates an exterior sensor signal representing conditions around the vehicle 1 every predetermined period, and outputs the generated exterior sensor signal to the auto reply device 6. An exterior sensor signal is an example of vehicle exterior information representing conditions around the vehicle 1.

The individual vehicle interior sensors 3 are sensors for sensing conditions of the interior of the vehicle 1, and include, for example, a vehicle interior camera installed to take pictures of the interior of the vehicle 1 or a thermometer that measures the temperature inside the vehicle. Each vehicle interior sensor 3 generates an interior sensor signal representing conditions of the interior of the vehicle 1 every predetermined period, and outputs the generated interior sensor signal to the auto reply device 6. An interior sensor signal is an example of vehicle interior information representing conditions of the interior of the vehicle 1.

The notification device 5 is installed in the interior of the vehicle 1 and notifies an occupant of a reply represented by reply information generated by the auto reply device 6. To achieve this, the notification device 5 includes, for example, at least one of a speaker or a display. Upon receiving a notification signal representing a reply to an occupant from the auto reply device 6, the notification device 5 notifies the driver of the reply by a voice from the speaker or by the display displaying a message or an image or playing a video.

The auto reply device 6 replies according to an utterance of an occupant of the vehicle 1.

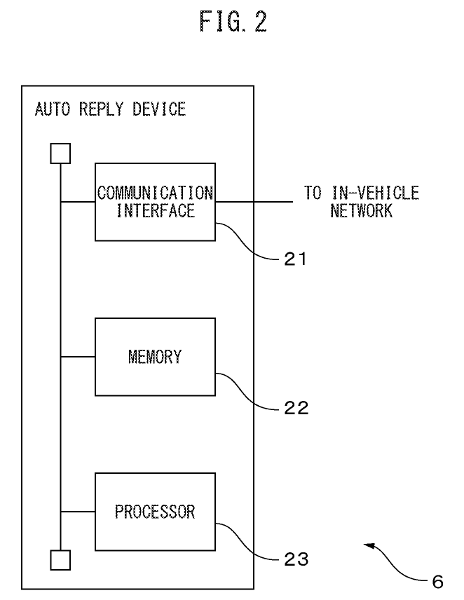

FIG. 2 illustrates the hardware configuration of the auto reply device 6. As illustrated in FIG. 2, the auto reply device 6 includes a communication interface 21, a memory 22, and a processor 23. The communication interface 21, the memory 22, and the processor 23 may be configured as separate circuits or a single integrated circuit.

The communication interface 21 includes an interface circuit for connecting the auto reply device 6 to another device inside the vehicle. The communication interface 21 passes exterior sensor signals received from the respective vehicle exterior sensors 2 and interior sensor signals received from the respective vehicle interior sensors 3 to the processor 23. The communication interface 21 also passes a voice signal received from the microphone 4 to the processor 23. The communication interface 21 also passes information received from a device outside the vehicle 1 via a wireless communication terminal (not illustrated) to the processor 23. Such information includes, for example, weather information or traffic information. Weather information and traffic information are other examples of vehicle exterior information. Further, the communication interface 21 outputs a notification signal received from the processor 23 to the notification device 5 or a control command received from the processor 23 to a vehicle-mounted device.

The memory 22, which is an example of a storage unit, includes, for example, volatile and nonvolatile semiconductor memories, and stores various types of data used in an auto reply process executed by the processor 23. More specifically, the memory 22 stores history of reply representing replies to past utterances of an occupant of the vehicle 1 and various types of data used for generating candidates for reply. For each reply, the history of reply includes text data representing an utterance, the type of vehicle-mounted device related to the reply, details of the reply, and data representing vehicle interior information and vehicle exterior information at the time of making the reply. In addition, the memory 22 may temporarily store exterior sensor signals received from the respective vehicle exterior sensors 2, interior sensor signals received from the respective vehicle interior sensor 3, and a voice signal received from the microphone 4. Further, the memory 22 stores various types of data generated during execution of the auto reply process, e.g., command data and possible utterance data for each candidate for reply.

The processor 23 includes one or more central processing units (CPUs) and a peripheral circuit thereof. The processor 23 may further include another operating circuit, such as a logic unit, an arithmetic unit, or a graphics processing unit. The processor 23 executes the auto reply process.

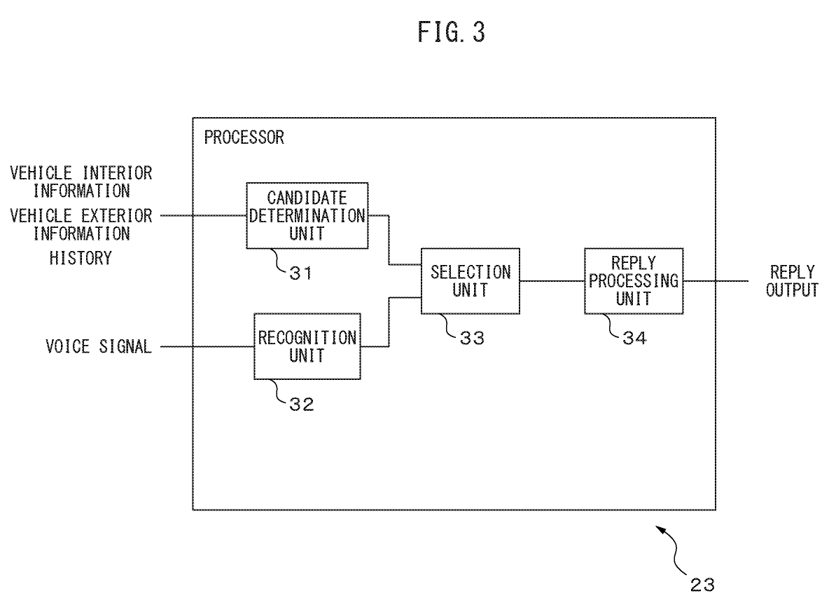

FIG. 3 is a functional block diagram of the processor 23, related to the auto reply process. The processor 23 includes a candidate determination unit 31, a recognition unit 32, a selection unit 33, and a reply processing unit 34. These units included in the processor 23 are, for example, functional modules implemented by a computer program executed by the processor 23, or may be dedicated operating circuits provided in the processor 23.

The candidate determination unit 31 determines candidates for reply that may be requested by an occupant of the vehicle 1 from types of possible reply.

The types of possible reply include operation of one or more vehicle-mounted devices, output of voice or display of video via the notification device 5, a search for information over a network via a wireless communication terminal, or a combination thereof. Operation of vehicle-mounted devices includes, for example, changing the temperature setting of an air conditioner, opening or closing a window, turning on or off an indoor light, and playing or stopping video content or audio content.

To determine candidates for reply, the candidate determination unit 31 refers to at least one of history of reply, vehicle exterior information, and vehicle interior information. In the present embodiment, the candidate determination unit 31 determines candidates for reply by inputting at least one of history of reply, vehicle exterior information, and vehicle interior information into a candidate determination model pre-trained to output candidates for reply, based on a predetermined machine learning technique. The candidate determination model may be, for example, a model based on a decision tree, a model based on a “deep neural network (DNN),” or a model based on boosting. A candidate determination model based on a DNN is configured to include, for example, fully-connected layers and an output layer in this order from the input side. The output layer calculates a value indicating confidence for each type of possible reply by a softmax operation. In this case, the candidate determination unit 31 converts vehicle interior information, vehicle exterior information, or history of reply to be inputted into the candidate determination model to a vector in accordance with a predetermined conversion rule, and inputs the vector into the candidate determination model. The candidate determination model may be a model with stacked blocks each including an attention sublayer and a feed forward sublayer. Even in this case, a layer that calculates a value indicating confidence for each type of reply by a softmax operation is provided as an output layer. In this case, the candidate determination unit 31 converts vehicle interior information, vehicle exterior information, or history of reply to be inputted into the model to text data (for example, converts the name of a sensor by which the vehicle interior information is obtained and the value of a sensor signal, which is the vehicle interior information, to text data), and inputs the text data into the candidate determination model. The candidate determination unit 31 determines types of reply whose confidence is not less than a predetermined threshold or a predetermined number (integer of 2 or more) of types of reply in descending order of confidence as candidates for reply. The use of such a candidate determination model enables the candidate determination unit 31 to determine appropriate candidates for reply depending on the current conditions of the vehicle 1. Such a candidate determination model is pre-trained according to a supervised learning technique depending on the model (e.g., backpropagation), using training data including a large number of combinations of vehicle exterior information, vehicle interior information, or history of reply inputted into the candidate determination model and details of reply.

Alternatively, the ranges of values corresponding to vehicle interior information, vehicle exterior information, and history of reply may be preset for each type of reply. The candidate determination unit 31 may determine types of reply such that the values of the latest vehicle interior information and vehicle exterior information and the history of reply in a most recent predetermined period are within the set ranges, as candidates for reply.

When candidates for reply are determined, the candidate determination unit 31 determines, for each of the candidates for reply, a combination of possible utterance data, which is text data, representing an utterance expected at requesting the reply and command data for making the reply. To achieve this, the candidate determination unit 31 determines a combination of corresponding possible utterance data and command data for each candidate for reply by referring to a table that is prepared for each type of reply and that represents combinations of possible utterance data and command data. Such a table is pre-stored in the memory 22. Command data indicates a device to be controlled by a reply process and details of control in the reply process.

The candidate determination unit 31 updates the candidates for reply appropriately by executing the above-described process every predetermined period, every time the vehicle 1 travels a predetermined distance, or every time the value of an exterior sensor signal included in vehicle exterior information or the value of an interior sensor signal included in vehicle interior information changes more than a predetermined update threshold. Alternatively, the candidate determination unit 31 may update the candidates for reply by executing the above-described process every time a predetermined period elapses from the last execution of the reply process.

The recognition unit 32 recognizes an utterance of an occupant of the vehicle 1 from a voice signal picked up by the microphone 4. To achieve this, the recognition unit 32 inputs a voice signal whose average volume in a most recent predetermined period exceeds an utterance detection threshold among voice signals generated by the microphone 4 into a voice recognition model, thereby recognizing an utterance represented by the voice signal, and generates text data representing the utterance as actual utterance data. Such a voice recognition model is configured, for example, as a DNN having an attention mechanism or a DNN having a recursive structure, such as a recurrent neural network (RNN) or Long Short-Term Memory (LSTM). Alternatively, the voice recognition model may be configured as a GMM-HMM based on a mixture Gaussian distribution and a hidden Markov model or as a DNN-HMM based on a DNN and a hidden Markov model. The recognition unit 32 may divide a voice signal into frames each having a predetermined length of time, extract one or more features of voice for each frame, and input the features of each frame into the voice recognition model in chronological order, thereby recognizing an utterance represented by the voice signal. The features of each frame may be, for example, predetermined elements of the cepstrum of the frame.

When actual utterance data representing an utterance is obtained, the recognition unit 32 outputs the actual utterance data to the selection unit 33.

The selection unit 33 selects a candidate for reply corresponding to the possible utterance data that best matches the recognized utterance from among the candidates for reply. To achieve this, the selection unit 33 calculates a degree of match between the actual utterance data representing the utterance and the possible utterance data for each of the candidates for reply. The selection unit 33 then selects a candidate for reply corresponding to the possible utterance data whose degree of match is the highest as the best match for the utterance.

As the degree of match, the selection unit 33 calculates a Levenshtein distance between the possible utterance data and the actual utterance data for each of the candidates for reply. In this case, the degree of match is higher as the Levenshtein distance is shorter. Alternatively, the selection unit 33 may calculate another index indicating the degree of match between two pieces of text data, such as an edit distance, as the degree of match. Alternatively, the selection unit 33 may calculate the degrees of match between the actual utterance data and the respective pieces of possible utterance data by inputting the actual utterance data and the pieces of possible utterance data into a model pre-trained to calculate the degrees of match between actual utterance data and pieces of possible utterance data. The model that calculates the degrees of match is configured as a LLM with stacked blocks each including an attention sublayer and a feed forward sublayer. In this case, a layer that calculates a value indicating a degree of match for each piece of possible utterance data by a softmax operation or a sigmoid operation is provided as an output layer of the model. The LLM that calculates the degrees of match may be a model that executes a smaller amount of computation than a LLM described below that generates command data from actual utterance data because the types of output are limited.

When even the highest degree of match of possible utterance data is less than a predetermined selection threshold, the occupant's utterance is probably a request for reply different from any of the candidates for reply. Thus the selection unit 33 may be configured so that none of the candidates for reply will be selected in such a case. When a value that decreases as the degree of match increases, such as a Levenshtein distance, is calculated as an index indicating the degree of match, the selection unit 33 compares the inverse of the index or the inverse of the sum of the index and a predetermined offset value (e.g., 1) with the selection threshold.

The selection unit 33 notifies the reply processing unit 34 of the selected candidate for reply and corresponding command data. When none of the candidates for reply is selected, the selection unit 33 notifies the reply processing unit 34 of this fact and the actual utterance data.

The reply processing unit 34 replies according to the command data corresponding to the selected candidate for reply notified by the selection unit 33. For example, when the command data indicates that the device to be controlled is an air conditioner and that details of the reply process are changing the temperature setting by a predetermined temperature, the reply processing unit 34 outputs a control signal for changing the temperature setting by the predetermined temperature to the air conditioner via the communication interface 21. When the command data indicates that the device to be controlled is a wireless communication terminal and that details of the reply process are searching for a predetermined item, the reply processing unit 34 outputs a request signal for searching for the predetermined item via the communication interface 21 and the wireless communication terminal to a search server (not illustrated) installed outside the vehicle 1. Upon receiving a search result from the search server via the wireless communication terminal and the communication interface 21, the reply processing unit 34 makes the notification device 5 display the search result via the communication interface 21. Alternatively, when the command data indicates that the device to be controlled is the notification device 5 and that details of the reply process are playing video content, the reply processing unit 34 outputs a control signal for making the notification device 5 play video content via the communication interface 21.

When notified by the selection unit 33 that none of the candidates for reply is selected, the reply processing unit 34 generates command data by inputting the actual utterance data into a generation model pre-trained to generate command data corresponding to the utterance. The reply processing unit 34 then executes the reply process according to the generated command data. The generation model is configured as a LLM with stacked blocks each including an attention sublayer and a feed forward sublayer.

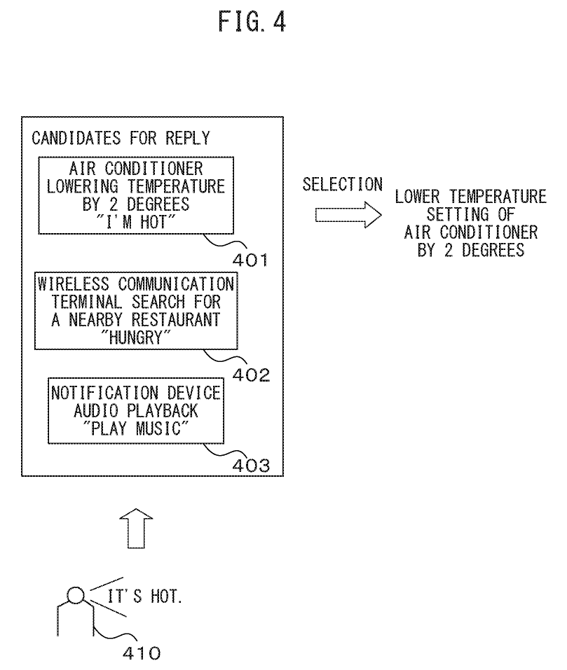

FIG. 4 illustrates an overview of the reply process of the present embodiment. In this figure, three candidates 401 to 403 for reply are set. The candidate 401 is a combination of command data indicating lowering the temperature setting of the air conditioner by 2 degrees and possible utterance data “I'm hot.” The candidate 402 is a combination of command data indicating searching for a restaurant near the current location via the wireless communication terminal and possible utterance data “Hungry.” The candidate 403 is a combination of command data indicating playing audio content by the notification device and possible utterance data “Play music.” When an occupant 410 says “It's hot,” the candidate 401 corresponding to possible utterance data “I'm hot,” which is closest to the utterance, is selected among the candidates, and the reply process is executed to lower the temperature setting of the air conditioner by 2 degrees.

When the reply process is finished, the reply processing unit 34 stores reply execution data representing details of the executed reply process as history of reply in the memory 22. In the reply execution data, the reply processing unit 34 may further include the actual utterance data related to the reply process and the possible utterance data and the command data for the selected candidate for reply. In the reply execution data, the reply processing unit 34 may further include the position of the vehicle 1, the date and time, vehicle interior information, and vehicle exterior information at the time of execution of the reply process.

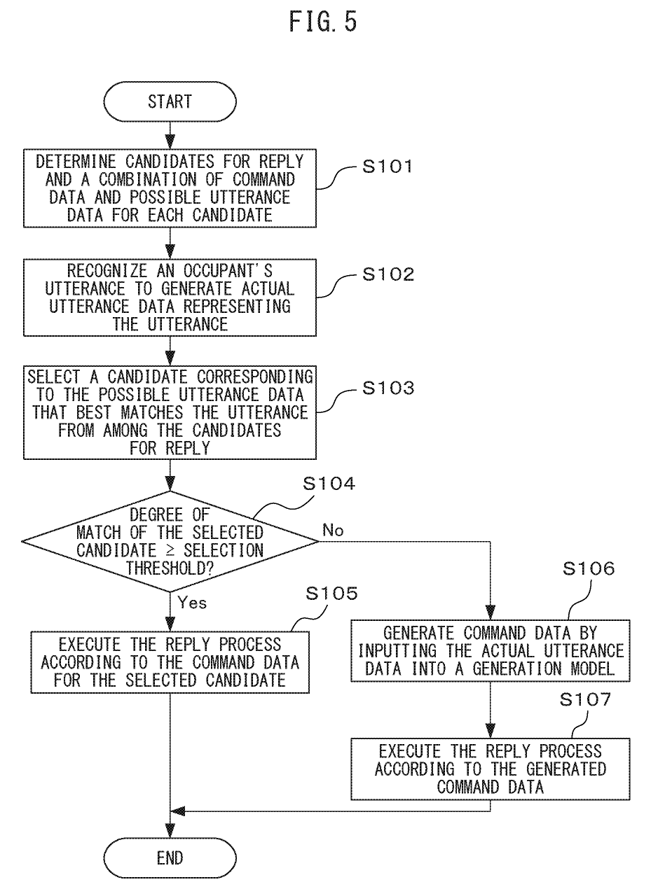

FIG. 5 is an operation flowchart of the auto reply process of the present embodiment. The processor 23 executes the auto reply process according to this operation flowchart.

The candidate determination unit 31 determines candidates for reply, based on at least one of vehicle interior information, vehicle exterior information, and history of reply, and determines, for each candidate for reply, a combination of command data and possible utterance data (step S101). The recognition unit 32 recognizes an occupant's utterance, based on a voice signal generated by the microphone 4, and generates actual utterance data representing the utterance (step S102). The selection unit 33 selects a candidate for reply corresponding to the possible utterance data that best matches the occupant's utterance from among the candidates for reply (step S103).

The reply processing unit 34 determines whether the degree of match between the actual utterance data and the possible utterance data for the selected candidate for reply is not less than a predetermined selection threshold (step S104). When the degree of match is not less than the selection threshold (Yes in step S104), the reply processing unit 34 executes the reply process according to the command data for the selected candidate for reply (step S105).

When the degree of match is less than the selection threshold (No in step S104), the reply processing unit 34 generates command data depending on the utterance by inputting the actual utterance data into a generation model for generating command data (step S106). The reply processing unit 34 then executes the reply process according to the generated command data (step S107).

As has been described above, the auto reply device selects a candidate for which related possible utterance data best matches actual utterance data representing an occupant's utterance from among candidates for reply that have been determined based on vehicle interior information or the like. The auto reply device then executes a reply process according to the command data for the selected candidate for reply. Thus, the auto reply device can execute a reply process depending on the occupant's utterance by relatively simple processing after the utterance. The auto reply device can therefore shorten a wait time from an occupant's utterance until reply.

When the degree of match between actual utterance data and possible utterance data of any of the candidates for reply is less than a predetermined selection threshold, the auto reply device generates command data by inputting the actual utterance data into a generation model for generating command data. Thus, the auto reply device can execute an appropriate reply process depending on an occupant's utterance even if none of the prepared candidates for reply matches the utterance.

According to a modified example, the processor 23 of the auto reply device 6 may further include an update unit that updates the candidate determination model. The update unit updates the candidate determination model according to a supervised learning technique depending on the candidate determination model, using combinations of command data for the case where none of the candidates for reply is selected, which is stored in the memory 22 as history of reply, and vehicle interior information, vehicle exterior information, or history of reply inputted into the candidate determination model as training data. To this end, the update unit may update some of weighting factors of the candidate determination model according to a LoRA technique. Alternatively, the update unit may substitute actual utterance data and command data generated by the generation model for a combination of possible utterance data and command data associated with vehicle interior information and vehicle exterior information for the case where none of the candidates for reply is selected. In this way, when none of the prepared candidates for reply is selected, the algorithm for determining candidates for reply is updated using actual utterance data and command data generated by the generation model, so that more appropriate candidates will be included in the candidates for reply.

The computer program for achieving the auto reply process of the above-described embodiment or modified example may be provided, for example, in a form recorded on a computer-readable portable storage medium as a computer program product.

As described above, those skilled in the art may make various modifications according to embodiments within the scope of the present invention.

What is claimed is:

1. An auto reply device comprising:
a processor configured to:
determine candidates for reply that may be requested by an occupant of a vehicle, based on at least one of history of reply to an utterance of the occupant, vehicle exterior information representing conditions around the vehicle, and vehicle interior information representing conditions inside the vehicle,
determine, for each of the candidates for reply, a combination of possible utterance data representing an utterance expected at requesting the reply and command data for making the reply,
recognize an utterance of the occupant from a voice signal picked up by a microphone installed in the vehicle,
select a candidate for reply corresponding to the possible utterance data that best matches the recognized utterance from among the candidates for reply, and
reply according to the command data for the selected candidate for reply.

2. The auto reply device according to claim 1, wherein the processor determines the candidates for reply by inputting at least one of the history of reply, the vehicle exterior information, and the vehicle interior information into a candidate determination model pre-trained to determine the candidates for reply.

3. The auto reply device according to claim 1, wherein the processor calculates a degree of match between the recognized utterance and the possible utterance data for each of the candidates for reply, and does not select any of the candidates for reply when the degree of match of any of the candidates for reply is less than a predetermined selection threshold, and
when none of the candidates for reply is selected, the processor generates the command data by inputting the recognized utterance into a generation model pre-trained to generate the command data corresponding to the utterance, and replies according to the generated command data.

4. An auto reply method comprising:
determining candidates for reply that may be requested by an occupant of a vehicle, based on at least one of history of reply to an utterance of the occupant, vehicle exterior information representing conditions around the vehicle, and vehicle interior information representing conditions inside the vehicle;
determining, for each of the candidates for reply, a combination of possible utterance data representing an utterance expected at requesting the reply and command data for making the reply;
recognizing an utterance of the occupant from a voice signal picked up by a microphone installed in the vehicle;
selecting a candidate for reply corresponding to the possible utterance data that best matches the recognized utterance from among the candidates for reply; and
replying according to the command data for the selected candidate for reply.

5. A non-transitory recording medium that stores a computer program for auto reply, the computer program causing a computer to execute a process comprising:
determining candidates for reply that may be requested by an occupant of a vehicle, based on at least one of history of reply to an utterance of the occupant, vehicle exterior information representing conditions around the vehicle, and vehicle interior information representing conditions inside the vehicle;
determining, for each of the candidates for reply, a combination of possible utterance data representing an utterance expected at requesting the reply and command data for making the reply;
recognizing an utterance of the occupant from a voice signal picked up by a microphone installed in the vehicle;
selecting a candidate for reply corresponding to the possible utterance data that best matches the recognized utterance from among the candidates for reply; and
replying according to the command data for the selected candidate for reply.
